(19) United States
(12) Patent Application Publication
(10) Pub. No.: US 2016/0075449 A1
(43) Pub. Date: Mar. 17, 2016

(54) BAGGAGE HANDLING SYSTEM FOR AN AIRPORT

(71) Applicant: SIEMENS AKTIENGESELLSCHAFT, München (DE)

(72) Inventor: ROLAND ZIEGLER, FUERTH (DE)

(21) Appl. No.: 14/787,537

(22) PCT Filed: Apr. 11, 2014
(86) PCT No.: PCT/EP2014/057351

§ 371 Date: Oct. 28, 2015

(30) Foreign Application Priority Data
Apr. 29, 2013 (DE) 10 2013 207 810.2

(51) Int. Cl. B64F 1/36; B65G 43/08

(52) U.S. Cl. CPC B64F 1/368; B65G 43/08; B65G 2811/0678

(57) ABSTRACT

An airport baggage handling system includes a sorting conveyor system transporting baggage pieces to sorting targets on conveyor routes with switch points, being settable in conveying directions and having a superordinate control system and control units for switch points. A departure processing system registers a baggage piece, accepts baggage piece attributes and provides identification data of the baggage piece. A baggage notification system forms a baggage piece notification from the identification data and attributes and transmits it to the control system. The control system produces a notification list from notifications and a sorting plan with identification data-sorting target assignments and determines route tables with sorting target-conveying direction assignments for switch points. An auxiliary handling system accepts entered attributes and identification data from the departure processing system, forms the notification and transmits it to the control system, permitting sorting conveyor system operation upon baggage notification system failure.

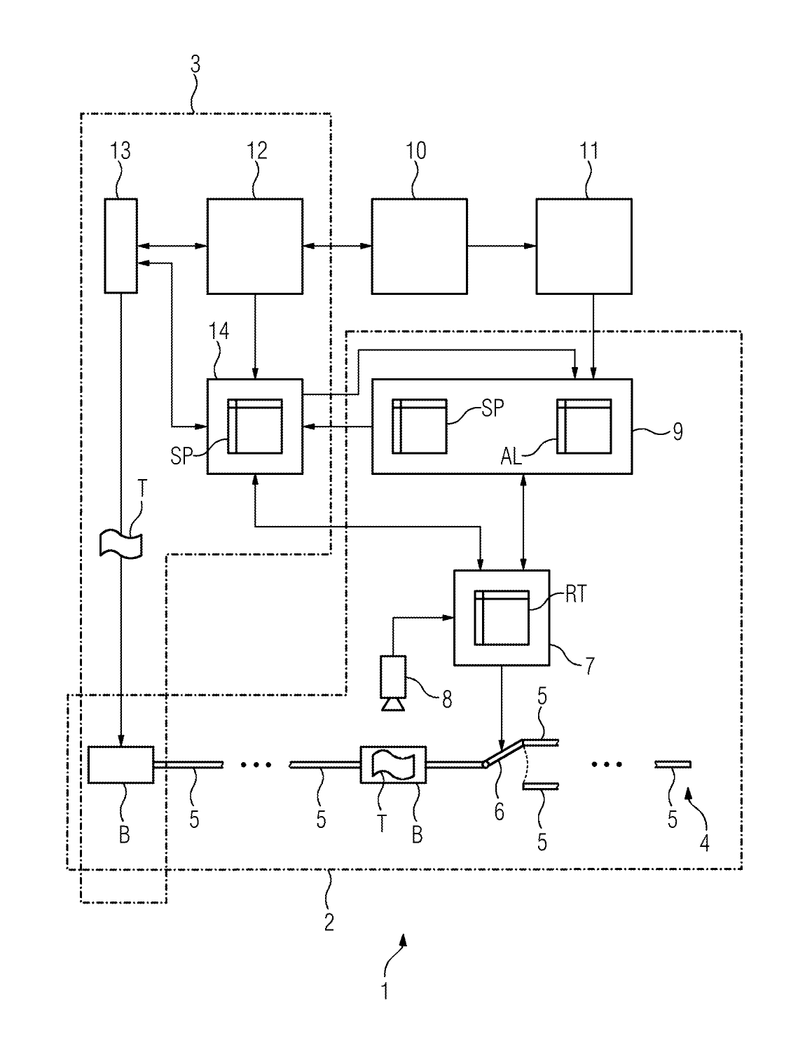

The invention relates to a baggage handling system for an airport as claimed in the preamble of claim 1.

Such an airport baggage handling system has a sorting conveyor system for transporting baggage pieces to sorting targets on conveyor routes. The conveyor routes are formed by conveyor elements known per se and have switch points that can be set at branching positions, at which the baggage pieces are transported onwards in different directions of conveyance. The sorting conveyor system has a superordinate control system and control units assigned to the switch points. The control system is embodied to prepare a message list of transmitted baggage piece messages and a sorting plan with identification data-sorting target assignments and to specify route tables with sorting target-conveying direction assignments for the switch points. Each of the control units is embodied to request the sorting target of a baggage piece from the control system on the basis of an item of identification data of the baggage piece detected before the switch point is reached, and to set the conveying direction assigned to the sorting target on the basis of the specified route table. An airport baggage handling system of this type and a controller for such a system is known from publication DE 103 39 951 A1.

The airport baggage handling system also has a departure processing system for notification of a baggage piece for a flight, which is known internationally for example under the name common use terminal equipment. At check-in desks able to be operated by airport staff, known internationally as check-in counters, or at automatic check-in terminals able to be operated by passengers, known internationally as self-service check-ins, attributes assigned to the baggage piece, comprising
a carrier airline code, known internationally as the carrier code,
a flight number, known internationally as the flight number,
a travel class, known internationally as the cabin class,
a travel itinerary, known internationally as the itinerary,
   as well as other attributes relevant for the sorting, are recorded and an item of identification data relevant for the sorting is issued. The item of identification data is transferred to a bearer element to be linked to the baggage piece, known internationally as a baggage tag. For example an item of identification data embodied as a barcode is printed on a baggage tag embodied as a roll of adhesive tape, which can then be glued around a handle of a baggage piece. This internationally-standardized process is described in the Passenger Services Conference Resolution Manual, published by the International Air Transport Association, abbreviated to IATA.

The airport baggage handling system also has a baggage notification system, known internationally as the baggage message system, which is embodied to accept the baggage piece attributes entered in the departure processing system and the identification data issued and to create a baggage piece notification, known internationally as the baggage source message, for a baggage piece to be transported. The baggage source message is transmitted to the control system of the sorting conveyor system as a notification of a transport of the baggage piece to be carried out. The baggage message system can be formed for example by a flight handling system of an airline, which is known internationally as an airline departure control system. However a separate baggage notification system, known internationally as a baggage message system, can also be used, which receives baggage messages from the departure processing systems of the various airlines and sends them to the control system of the sorting conveyor system.

The underlying object of the invention is now to provide an airport baggage handling system of the type described as the start, which makes it possible, even with failures of parts of the system, for the baggage pieces still to be transported to their sorting targets.

The object is achieved in accordance with the invention by a generic airport baggage handling system with the features specified in the characterizing part of claim 1. Accordingly the baggage handling system has an auxiliary handling system which is embodied to accept from the departure processing system the baggage piece attributes entered on notification of a baggage piece and the issued item of identification data, to form the baggage piece message therefrom and to transfer this to the control system, and also to emulate the sorting plan provided by the control system. In addition each of the control units is embodied, on the basis of the item of identification data of a baggage piece detected upstream of the switch point, to request its sorting target from the auxiliary handling system as an alternative. Even with a baggage message system that is out of action, this enables the sorting conveyor system to continue to be operated, since the control system is supplied with the baggage messages as an alternative via the auxiliary handling system. When the departure processing system is in operation the sorting conveyor system can continue to be operated, even if its superordinate control system were to fail since, on the basis of the sorting plan emulated in the auxiliary handling system and the supplied baggage messages, each control unit, for an identified baggage piece, can request the sorting target from the auxiliary handling system, and on the basis of the predetermined routing table, can set the conveying direction of the switch point to the sorting target.

In a preferred embodiment of the inventive airport baggage handling system the auxiliary handling system is embodied as an alternative to accept the baggage piece attributes assigned to a baggage piece, to issue an auxiliary item of identification data assigned to the baggage piece and to transmit this to an auxiliary baggage tag to be linked to the baggage piece, to form an auxiliary baggage piece message from the auxiliary item of identification data and the baggage piece attributes and to transmit these to the control system, wherein the control system is embodied to accept the transmitted auxiliary baggage piece messages into the message list and to provide auxiliary identification data-sorting target assignments in the sorting plan. This enables the sorting conveyor system to continue to be operated via the auxiliary handling system even if the departure processing system fails, in that an alternative acceptance of the baggage piece attributes, for example by manual entry, and an alternative issuing of an auxiliary item of identification data as well as its transmission of the auxiliary baggage tag is made possible. The use of auxiliary baggage tags also allows a full use of the baggage tracking function of the control system.

Preferably the auxiliary handling system and the departure processing system of the inventive airport baggage handling system are able to be operated via a common operator interface at a baggage handling position of the airport. A baggage handling position can be a check-in counter able to be operated by airport staff or a self-service check-in able to be operated by the passenger. The operator interface can be formed by a touch screen with pushbutton functions and scaling function, which allows operation of both the departure processing system and also the auxiliary handling system.

In an advantageous embodiment of the inventive airport baggage handling system the auxiliary handling system is able to be integrated into an existing baggage handling position with departure processing system and operating interface such that computing and memory devices with data processing programs of the auxiliary handling system are able to be disposed or executed remotely from the baggage handling system and are able to be operated from the operating interface of the baggage handling position via a data network or via a cloud computing service. This makes it possible to integrate the auxiliary handling system into a baggage handling system already existing at an airport, especially into existing check-in counters, without having to making alterations to these facilities.

Further characteristics and advantages of the inventive airport baggage handling system emerge from the exemplary embodiments described in greater detail below, which refer to the drawing, in the single FIGURE of which the baggage handling system is illustrated schematically with different failure scenarios.

In accordance with the single FIGURE a baggage handling system 1 for an airport comprises a sorting conveyor system 2. By means of the sorting conveyor system 2 a baggage piece B is able to be transported from a baggage check-in position, for example at a check-in counter 3, on one of a plurality of conveyor routes to a sorting target at a sorting terminal point 4. The conveyor routes are formed by conveyor elements 5, such as for example conveyor belts with transport trays and the like and have settable switch points 6 for different conveying directions at branch points, in which a baggage piece B is able to be transported on from the switch point 6 on its conveyor route. To this end a control unit 7 is assigned to each switch point 6, which defines the conveyor direction to be set for a baggage piece B transported to the switch point 6 on the basis of an item of identification data assigned to this baggage piece B. The item of identification data can be embodied as a barcode and is assigned to the baggage piece B by a baggage tag T embodied as an adhesive tape roll attached to said piece. A read device 8 is disposed upstream of the switch point 6, which reads the item of identification data from the baggage tag T and transfers it to the control unit 7. The control units 7 assigned to the switch points 6 are coupled to a superordinate control system 9 of the sorting conveyor system 2, which, in order to implement the conveyor routes, provides the control units 7 for each branch point with an assignment of conveyor directions to sorting targets in the form of a route table RT. The control unit 7, after receiving an item of identification data, receives a query about a sorting target assigned to the item of identification data. For this the control system 9 provides a sorting plan SP which contains precisely this assignment of sorting targets to identification data of baggage pieces B. With the sorting target of the baggage piece B returned by the control system 9, the control unit 7 can determine from the route table RT the conveying direction, which is then set by a setting element of the switch point 6. As well as the sorting plan SP, a baggage message list AL is maintained in the superordinate control system 9 in which all transport tasks of the sorting conveyor system 2 to be carried out are listed.

The transport tasks are supplied to the control system 9 as baggage piece messages either directly by a baggage handling system 10 of an airline or indirectly via a separate baggage piece message system 11. A baggage message of a baggage piece B to be transported is formed from the item of identification data as well as from further baggage piece attributes assigned to the baggage piece B, such as an airline code, a flight number, a cabin class and an itinerary for example.

At the check-in counter 3 the baggage handling system 1 comprises a departure processing system 12 with a user interface 13 for airport staff. The user interface 13 has input means for entering the baggage piece attributes of a checked-in baggage piece B. The departure processing system 12 is embodied, for the checked-in baggage piece B, to issue an item of identification data and transfer it to a baggage tag T. To this end the user interface 13 has a printing device, by means of which the item of identification data embodied as a barcode is printed on a roll of adhesive tape, which is then attached to the baggage piece B, before said piece is transported away from the check-in counter of the sorting conveyor system 2.

In accordance with the invention the airport baggage handling system 1 has an auxiliary handling system 14 to which the accepted baggage piece attributes as well as the issued identification data of checked-in baggage pieces are sent in parallel to the baggage message system 11 by the departure processing system 12. In the event of the baggage message system 11 being out of operation, the auxiliary handling system 14 is embodied to form the baggage piece messages itself and to transmit them to the control system 9. This enables the sorting conveyor system 2 to continue to be operated even in the event of a failure of the baggage message system.

Furthermore the auxiliary handling system 11 is embodied to emulate the sorting plan SP provided in the control system 9, so that, if the control system 9 is out of operation, the sorting conveyor system 2 can continue to be operated modified. If, because of a failure, the control system 9 does not react to a sorting target request from a control unit 7, said unit is embodied as an alternative to request the sorting target assigned to the item of identification data from the auxiliary handling system 14. This is taken from the sorting plan SP emulated there and transferred to the control unit 7, whereupon the latter can take the conveyor direction to be set from the route table RT.

In the event of the departure processing system 12 going out of operation, the auxiliary handling system 14 is embodied to accept the baggage piece attributes of a checked-in baggage piece B as an alternative. Furthermore an auxiliary identification can be issued by means of the auxiliary handling system 14 for baggage pieces B and transmitted to an auxiliary baggage tag. To this end the auxiliary handling system 14, which has an input/output means embodied as a touch screen as well as the printer device, is able to be operated through the user interface 13. The touch screen is expediently configured with pushbutton functions and scaling functions for simultaneous operation of the auxiliary handling system 14 and the departure processing system 12. The auxiliary handling system 14 is further configured to form auxiliary baggage messages from baggage piece attributes and auxiliary identification data and to transmit them to the control system 9 of the sorting conveyor system 2. The transmitted auxiliary baggage piece messages are accepted by the control system 9 into the message list. In the sorting plan the control system 9 provides the control units 7 in accordance with sorting target-auxiliary identification data assignments for the sorting target requirements.

The auxiliary handling system 14 is assigned in the exemplary embodiment shown to the check-in counter 3 as the baggage handling position of the airport. Computing and memory devices not shown with executable data processing programs of the auxiliary handling system 14 can also be assigned remotely to the baggage handling position or can be executed remotely and are able to be operated via a data network or via a cloud computing service from the user interface 13. This is especially advantageous if the inventive auxiliary handling system 14 is to be integrated into a baggage handling system already existing at an airport, especially into existing check-in counters 3. The inventive auxiliary handling system 14 is equally usable for automatic baggage handling positions.

Overall, by means of the inventive auxiliary handling system 14, operational restrictions of the sorting conveyor system 2 are very largely avoided in the event of faults in the computer systems 9, 10, 11 or 12 involved, in that baggage information present during baggage handling is tapped off and held ready by the auxiliary handling system 14.

1-4. (canceled)

5. A baggage handling system for an airport, comprising:
a sorting conveyor system for transporting baggage pieces to sorting targets on conveyor routes with switch points to be set in different conveying directions, said sorting conveyor system having a superordinate control system and control units assigned to said switch points;
a departure processing system for checking-in a baggage piece for a flight, said departure processing system accepting baggage piece attributes assigned to the baggage piece, including an airline code, a flight number, a travel class and an itinerary and issuing an item of identification data assigned to the baggage piece and transferring said item of identification data to a tag element to be linked to the baggage piece;
a baggage notification system for a baggage piece to be transported, said baggage notification system forming a baggage piece notification from said assigned item of identification data and said assigned baggage piece attributes and transmitting said baggage piece notification to said control system;
said control system providing a notification list of transmitted baggage piece notifications and a sorting plan with identification data-sorting target assignments and predetermining route tables with sorting target-conveying direction assignments for said switch points;
each of said control units, on a basis of an item of identification data of a baggage piece detected upstream of a switch point, requesting a sorting target from said control system and, on a basis of a predetermined routing table, setting a conveyor direction assigned to a sorting target;
an auxiliary handling system accepting said entered baggage piece attributes and said item of identification data issued by said departure processing system during notification of a baggage piece, forming a baggage piece message from said baggage piece attributes and said item of identification data, transferring said baggage piece message to said control system and emulating said sorting plan provided by said control system; and
each of said control units, on a basis of said item of identification data of a baggage piece recorded upstream of a switch point, requesting a sorting target as an alternative from said auxiliary handling system.

6. The baggage handling system according to claim 5, wherein:
said auxiliary handling system accepts said baggage piece attributes assigned to a baggage piece, issues an auxiliary item of identification data assigned to the baggage piece and transmits said auxiliary item of identification data to an auxiliary tag to be linked to the baggage piece, to form an auxiliary baggage message from said auxiliary item of identification data and said baggage piece attributes and to transmit said auxiliary baggage message to said control system; and
said control system accepts said transmitted auxiliary baggage piece messages for processing in said notification list and provides auxiliary identification data-sorting target assignments in said sorting plan.

7. The baggage handling system according to claim 5, which further comprises a user interface disposed at a baggage handling position of the airport for operating both said auxiliary handling system and said departure processing system.

8. The baggage handling system according to claim 7, wherein said auxiliary handling system is configured to be integrated into an existing baggage handling position with said departure processing system and said user interface to permit computing and memory devices with data processing programs of said auxiliary handling system to be disposed or executed remotely from the baggage handling position and to be operated via a data network or via a cloud computing service from said user interface of the baggage handling position.
